(19) United States
(12) Patent Application Publication
(10) Pub. No.: US 2024/0152736 A1
(43) Pub. Date: May 9, 2024

(54) SYSTEMS, METHODS, COMPUTER PROGRAMS FOR PREDICTING WHETHER A DEVICE WILL CHANGE STATE

(71) Applicant: Telefonaktiebolaget LM Ericsson (publ), Stockholm (SE)

(72) Inventors: Aydin SARRAF, Pierrefonds Québec (CA); Karthikeyan PREMKUMAR, Saint-Laurent QC (CA)

(73) Assignee: Telefonaktiebolaget LM Ericsson (publ), Stockholm (SE)

(21) Appl. No.: 18/282,027

(22) PCT Filed: Mar. 18, 2021
(86) PCT No.: PCT/IB2021/052289

§ 371 Date: Sep. 14, 2023

(51) Int. Cl. G06N 3/0464

(52) U.S. Cl. CPC G06N 3/0464

(57) ABSTRACT

A method (700) for predicting, for each device included in a set of devices, whether the device will change state at a particular future point in time. The method includes, for a first device within the set of devices, obtaining a first state value indicating the current state of the first device. The method also includes, for a second device within the set of devices, obtaining a second state value indicating the current state of the second device. The method also includes forming an input vector, the input vector comprising the first state value, the second state value, and a temporal feature (e.g., a set of one or more time values indicating the current time). The method also includes inputting the input vector into a trained machine learning (ML) model. The method also includes, after inputting the input vector into the trained ML model, obtaining a probability vector into the trained ML model, the probability vector comprising, for each device included in the set of devices, a state change prediction value indicating a likelihood that the device will change state at the particular future point in time.

### TECHNICAL FIELD

This disclosure relates to methods, devices, computer programs and carriers related to predicting, for each device included in a set of devices, whether the device will change state at a particular future point in time.

### BACKGROUND

The Internet-of-Things (IoT) refers to physical objects that have connectivity to the Internet (or another network). These physical objects (a.k.a., “devices”) contain electronics, software, sensors, and network connectivity, and many are battery operated. Many of these devices have sensors for collecting data regarding their surroundings and/or allow for remote control of the device. This creates opportunities for more direct integration of the physical world into computer-based systems. IoT technology provides improved efficiency, accuracy and economic benefit across business/technology domains like smart grids, smart homes, intelligent transportation and smart cities.

### SUMMARY

Certain challenges presently exist. For example, adding network connectivity (e.g., Wi-Fi™ connectivity) to battery operated IoT devices places a large demand on the IoT's batteries (e.g., Wi-Fi transceivers may consume much power). Wi-Fi power consumption varies due to RF performance, network condition, the applications running on the device. Wi-Fi protocols were designed primarily to optimize bandwidth, range, and throughput, but not power consumption. This makes Wi-Fi a poor choice for power-constrained applications that rely on battery power. Additionally, power consumption in Wi-Fi varies dramatically across various modes of operation and it's important to understand the different modes and optimize them to reduce overall power consumption. One strategy is to stay in the lowest power mode as much as possible and transmit/receive data quickly when needed. Hence, there is a need to predict the state of a device at a future point in time to determine whether or not to activate the device or allow it to enter (or maintain) a sleep state to save power.

Accordingly, in one aspect a method is provided for predicting, for each device included in a set of devices, whether the device will change state at a particular future point in time. The method includes, for a first device within the set of devices, obtaining a first state value indicating the current state of the first device. The method also includes, for a second device within the set of devices, obtaining a second state value indicating the current state of the second device. The method also includes forming an input vector, the input vector comprising the first state value, the second state value, and a temporal feature (e.g., a set of one or more time values indicating the current time). The method also includes inputting the input vector into a trained machine learning (ML) model. The method also includes, after inputting the input vector into the trained ML model, obtaining a probability vector from the ML model, the probability vector comprising, for each device included in the set of devices, a state change prediction value indicating a likelihood that the device will change state at the particular future point in time.

In another aspect a method is provided for producing a machine learning (ML) model for use in predicting, for each device included in a set of devices, whether the device will change state at a particular future point in time. The method includes obtaining a training dataset, the training dataset comprising a set of feature-label pairs including at least a first feature-label pair, each feature-label pair comprising at least a first feature vector and at least a first label vector. The method also includes generating the ML model using the training dataset as an input to a temporal convolutional network (TCN). The step of obtaining the training dataset includes: (1) for a first device within the set of devices, obtaining a first state value indicating the state of the first device at a first point in time; (2) for a second device within the set of devices, obtaining a second state value indicating the state of the second device at the first point in time; (3) after obtaining the first and second state values, generating the first feature vector of the first feature-label pair, wherein the first feature vector of the first feature-label pair comprises the first state value, the second state value, and a first temporal feature (e.g., set of one or more time values) indicating the first point in time; (4) obtaining a third state value indicating the state of the first device at a subsequent second point in time; (5) obtaining a fourth state value indicating the state of the second device at the subsequent second point in time; and (6) after obtaining the third and fourth state values, generating the first label vector of the first feature-label pair, wherein the first label vector of the first feature-label pair comprises the third state value, the fourth state value, and a second temporal feature indicating the second point in time.

In another aspect there is provided a computer program comprising instructions which when executed by processing circuitry of a controller causes the controller to perform the method. In another aspect there is provided a carrier containing the computer program, wherein the carrier is one of an electronic signal, an optical signal, a radio signal, and a computer readable storage medium.

In another aspect there is provided a controller, where the controller is adapted to perform the method of any embodiments disclosed herein. In some embodiments, the controller includes processing circuitry; and a memory containing instructions executable by the processing circuitry, whereby the controller is operative to perform the methods disclosed herein.

An advantage of the embodiments disclosed herein is that they enable conservation of battery power, thereby extending the life of the device. Another advantage is that they enable dynamic/intuitive IoT service composition. Typically, IoT services are manually configured by a user in an IoT cloud platform. For example, a user can configure the IoT services in the user's home such that when a motion sensor detects motion, the IoT system can, in response, open a door and turn on lights. A user, however, may not have the ability and/or understanding to manually create this configuration. By using any of the embodiments, the interdependence of the IoT devices and their state changes are automatically learned and the IoT system can be automated to dynamically configure the IoT service. Thus, the embodiments enable the improvement in user experience by enabling dynamic IoT services based on event prediction. Furthermore, embodiments can be used to make suggestions. For example, when motion is detected in the kitchen in the morning, the embodiments can be used to suggest switching on the coffee maker as part of the IoT service.

### BRIEF DESCRIPTION OF THE DRAWINGS

The accompanying drawings, which are incorporated herein and form part of the specification, illustrate various embodiments.

FIG. 1 illustrates a system according to an embodiment.

FIG. 2 illustrates dilated causal convolutions with different dilation parameters.

FIG. 3 is a graph showing the impact of history on accuracy.

FIG. 4 is a graph showing the impact of the number of kernels on accuracy.

FIG. 5 is a graph showing the impact of kernel size on accuracy.

FIG. 6 illustrates a neural network architecture according to an example embodiment.

FIG. 7 is a flowchart illustrating a process according to an embodiment.

FIG. 8 is a flowchart illustrating a process according to an embodiment.

FIG. 9 is a block diagram of a controller according to an embodiment.

### DETAILED DESCRIPTION

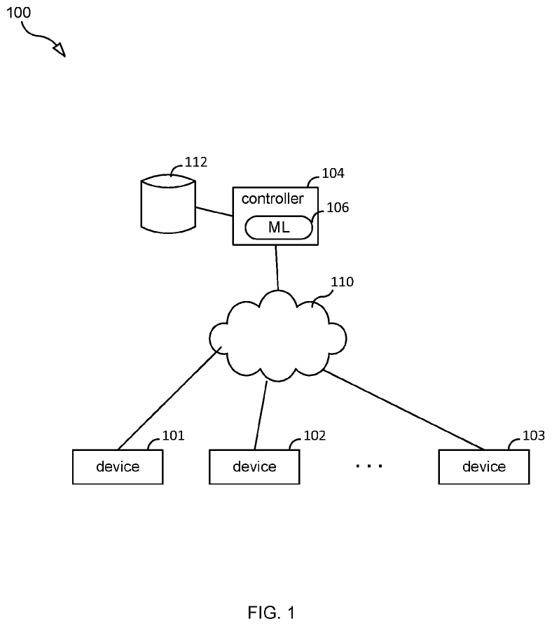

FIG. 1 illustrates a system 100 according to an embodiment. System 100 includes a set of N devices, which in this example includes at least device 101, device 102, and device 103, and a controller 104 for controlling the devices (e.g., for establishing a sleep/wake pattern for the devices). In the embodiment shown, controller 104 is connected to the devices via a network 110 (e.g., the Internet), and controller 104 has access to a database 112 containing, for each device, historical information about the device (e.g., information about the device's state at various different times in the past). The devices 101, 102, and 103 may be connected to network 110 via a Wi-Fi access point (not shown).

Advantageously, controller 104 includes (or has access to) a machine learning (ML) model 106 that learns the spatiotemporal patterns of the events that trigger the devices, which can be used to optimize the power consumption of periodic and event driven power constrained devices by preemptive scheduling of the wake-up/sleep interval of the devices. For example, in a smart home scenario, the Wi-Fi receiver of a device for operating a car garage door can sleep and wake-up based on learning the periodic user action of taking the car in/out of the garage on a regular basis. That is, the ML model 106 learns from spatiotemporal patterns of the devices to predict the state of the devices, which prediction can then be used to optimize the wake-up interval of the devices and develop various other value added services.

The embodiments disclosed herein are based on the consideration that the devices 101-103 are triggered based on the spatiotemporal events that are either happening in the context of their own realm of influence or due to the influence of an event happening in its neighboring device of influence. An event (E) is considered as the trigger of a device to change its state. The device wake-up time is expected to be centered around the event.

With the history of events that triggered the devices, a classification problem is formulated for multiple time series where each time series corresponds to one device. Since the activity of one device could be dependent on the activity of other devices, a single model is needed that can consider the event status of all devices at time t and predict their states at time t+1.

The Event Prediction Method

Assume that system 100 includes N devices and each device is distinguished by a device ID. For the device ID m and time t, a vector of the following form can be generated:

Vm,t=[temporal feature; device status; [spatial feature], [type], . . . ].

The temporal feature (which may be a single value or an array of values) depends on the time unit t of the sequence. For example, if the time unit is second then temporal feature may include: minute, hour, day, and month. The temporal feature is added to 1) capture the seasonality (e.g., if a device is active only on certain days of a month) and 2) decrease the prediction window as predicting the far future accurately is more difficult. In some embodiments, the spatial feature identifies a location, and the type identifies a device type.

For example, if the time unit of the sequence is hour, then Vm, 10=[20, 4; 1; 1; 3], which means that at 10 AM on April 20, device ID “m” was triggered/active in the living room (i.e., location 1) and device “m” is a type “3” device (e.g., garage door opener). All categorical features are label encoded, e.g. April is number 4 or living room is number 1. Accordingly, in this example the “temporal feature” comprises two values: a first value indicating day and a second value indicating a month. A device vector Vm,t may have more or less features that the one illustrated above.

To consider all the devices at time t, we concatenate the device vectors into a single vector of the form:

Xt=[V1,t;V2,t; . . . ;VN−1,t;VN,t].

The concatenation is performed to 1) capture the interactions/dependencies among different devices, 2) decrease the computational overhead by training one model for all devices as opposed to one model per device.

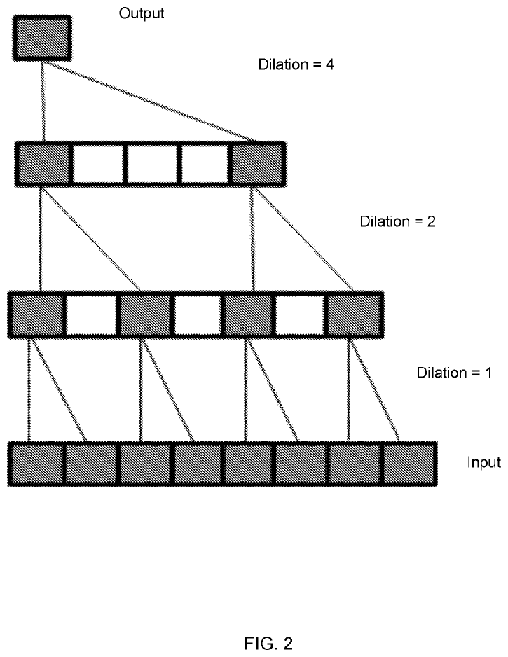

To learn the activity patterns of devices and their interactions, in some embodiments, a temporal convolutional network (TCN) is used. A TCN is a convolutional network that consists of special one-dimensional convolutions called “dilated causal” convolution. A standard convolution looks into the past and future, but casual convolution looks into the past only which is essential for time series forecasting. In order to decrease the depth of the network and increase the receptive field, dilation is added to the causal convolution. FIG. 2 illustrates dilated causal convolutions with different dilation parameters.

The TCN architecture has never been used to predict spatiotemporal events in an IoT controlled environment. The depth of the network depends on the look back parameter. We can use skip connections (a residual network) for a deep network to avoid the vanishing gradient problem.

A one-dimensional dilated causal kernel of size k>1 and dilation value d, abbreviated by (1, k, d)-DCC, can look back into (k−1)d elements of the sequence. Typically, the first residual block of the network consists of (1, k, 1)-DCCs, the second residual block consists of (1, k, 2)-DCCs, the third residual block consists of (1, k, 4)-DCCs, the fourth residual block consists of (1, k, 8)-DCCs, and so on. The number of kernels per residual block depends on the data but typically we want a small number of kernels (for example, 64 kernels) per residual block to reduce the risk of overfitting. Alternatively, more kernels can be used if combined with dropout or some type of regularization. It is recommended to use rectified linear units for the activation functions of the residual blocks.

The last layer is a dense layer with N neurons and uses softmax as the activation function. The softmax function outputs a probability vector:

Pt=[p1;p2; . . . ;pN]

that corresponds to the event activity status of each devices at time t. For example, if we use a 0.5 probability threshold, a probability vector Pt=[0.9; 0.4; 0.7; . . . ; 0.55] implies that device 1, 3 and N can expect an event activity (i.e., change state at time t) while device 2 doesn't at time t.

Advantages of a TCN architecture is that 1) convolutions can be performed in parallel to speed up the training and inference, 2) the training is more stable because TCN does not suffer from the exploding gradient problem and the residual architecture alleviates the vanishing gradient problem, and 3) TCN has a lower memory footprint.

An advantage of generating a single tensor (Xt) at time t is that such a high-dimensional mapping enables the capturing of the interdependencies among the devices and predict their future statuses more accurately.

The loss function of the TCN is the categorical cross entropy loss for multi-class classification. The categorical loss function is defined as follows

Loss=−Σᵢ₌₁ⁿyᵢ·log(ŷᵢ)

where yᵢ is a vector of binary values and ŷᵢ is a vector of probability values, i.e. yᵢ is the ground truth of an event while ŷᵢ is the model prediction. The cross-entropy loss function has shown to accelerate the training and alleviate the vanishing gradient problem.

### Example

In this example, the ARAS dataset (see reference [1]), which is a publicly available dataset (see www.cmpe.boun.edu.tr/aras/), was used for training the ML model.

For the neural network architecture, the TCN library (see reference [2]), which is publicly available (see github.com/philipperemy/keras-tcn), was used.

The ARAS dataset records the activities (27 activities) of 4 residents in two houses (2 residents in house A and 2 residents in house B) in a month by employing 20 sensors. To speed up the training for this high-dimensional embodiment, we just focus on sensors 3 and 4 in house A. We use 70% of the dataset for training and 30% for testing. For this dataset, we can simplify our representation of the input vector Xt where t is in second as follows.

Because the location of the sensor can be extracted from the sensor ID in this dataset, we can remove the location feature from Xt because the location is implicitly encoded in sensor ID. Moreover, the sensor ID can be encoded in the status ID vector. For example, if sensor 3 has status 0 and sensor 4 has status 1 then the first coordinate of the vector [0 1] can be reserved for sensor 3 and the second coordinate can be reserved for sensor 4. For the temporal feature, we only include the day of the week to capture the seasonality, i.e this feature can take values in {1, 2, . . . , 6, 7}. Additional temporal features (e.g. the hour) can be added at the expense of increasing the dimensionality and running time. In summary, if V3,t=[4; 0; 3] (i.e., on day 4 or Tuesday, at second t, the status of sensor 3 is 0 at location 3) and V4,t=[4, 1, 4] (i.e., on day 4 or Tuesday, at second t, the status of sensor 4 is 1 at location 4), we can represent Xt succinctly as Xt=[4, 0, 1].

Once Xt is known, Xt is mapped to a unique value using, for example, a dictionary. For this embodiment, the following dictionary is used:

class_dic = {
(1; 0; 1): 1
(1; 0; 0): 2
(1; 1; 0): 3
(1; 1; 1): 4
(2; 0; 1): 5
(2; 0; 0): 6
(2; 1; 0): 7
(2; 1; 1): 8
(3; 0; 1): 9
(3; 0; 0): 10
(3; 1; 0): 11
(3; 1; 1): 12
(4; 0; 1): 13
(4; 0; 0): 14
(4; 1; 0): 15
(4; 1; 1): 16
(5; 0; 1): 17
(5; 0; 0): 18
(5; 1; 0): 19
(5; 1; 1): 20
(6; 0; 1): 21
(6; 0; 0): 22
(6; 1; 0): 23
(6; 1; 1): 24
(7; 0; 1): 25
(7; 0; 0): 26
(7; 1; 0): 27
(7; 1; 1): 28
}

As an example, this dictionary maps the vector Xt=[4; 0; 1] to the value of 13. More generally, the dictionary maps each possible value of Xt to a unique number between and including 1 and 28 (in this example Xt is limited to one of the 28 values shown in the table above).

In the next step, the value to which Xt is mapped (i.e., 13 in this example) is one-hot encoded to produce the following vector: Xt=[0, 0, 0, 0, 0, 0, 0, 0, 0, 0, 0, 0, 1, 0, 0, 0, 0, 0, 0, 0, 0, 0, 0, 0, 0, 0, 0, 0], which is the standard one-hot encoding of the class 13 when there are a total of 28 possible classes.

Configurations

In this example, the following configuration parameters were chosen:

TCN Parameters:

forecast horizon = 1
history = 5
number of kernels = 32
kernel size = 4
nb_stacks = 1,
dilations = (1, 2, 4, 8, 16, 32)
padding = ′causal′,
use_skip_connections = False,
dropout_rate = 0.0,
return_sequences = False,
activation = ′relu′,
kernel_initializer = ′he_normal′,
use_batch_norm = False,
use_layer_norm = False,

(Refer to references [2], [3], and [4] and the TCN library for the definition of the parameters).

For the optimization algorithm, the Adam
optimizer [3] was used with the following parameters:

learning_rate = 0.001,
beta_1 = 0.9,
beta_2 = 0.999,
epsilon = 1e−7,
amsgrad = False.

As illustrated above, the forecast horizon is to 1 (next second) and the history to 5 (past 5 seconds), i.e. the input to the model is the following sequence: Xt-4; Xt-3; Xt-2; Xt-1; Xt. The output of the model is Xt+1. The forecast horizon is usually application dependent, but the history parameter can be tuned for further accuracy as long as the past data is available and increasing the history does not violate the memory and runtime constraints.

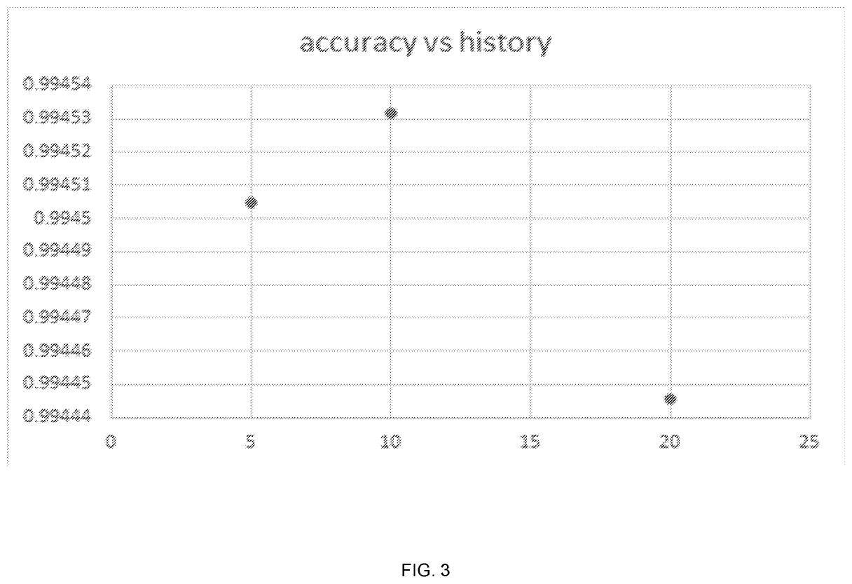

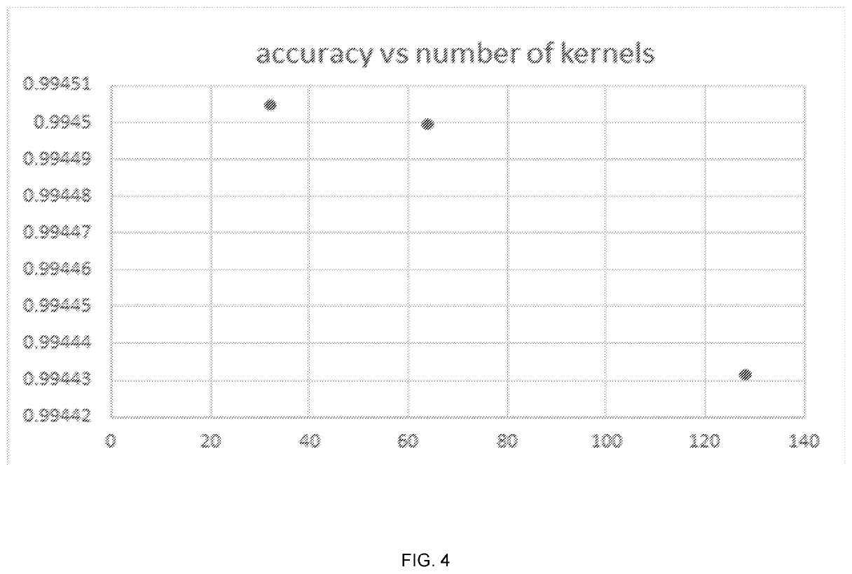

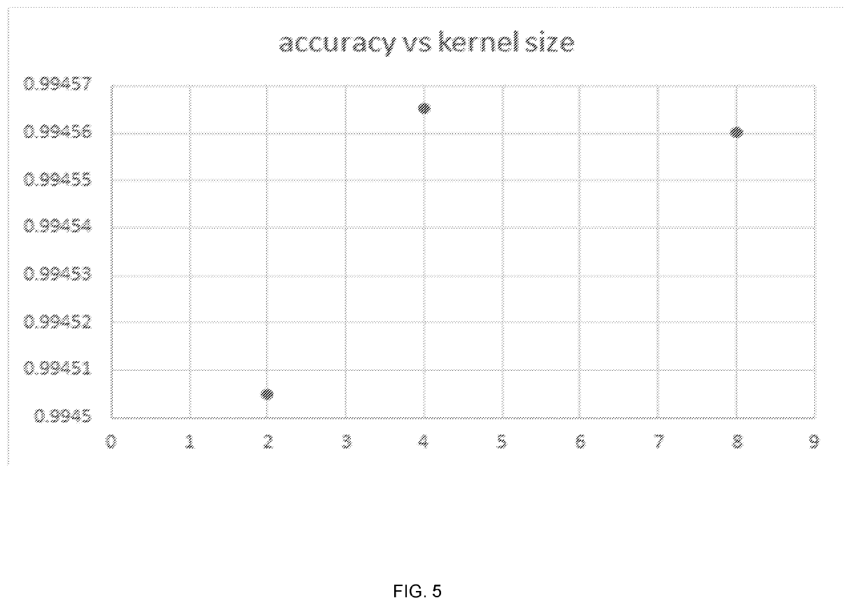

FIG. 3 is a graph showing the impact of history on accuracy (in this graph, kernel size is set to 2 and number of kernels is set to 32). FIG. 4 is a graph showing the impact of the number of kernels on accuracy (in this graph, kernel size is set to 2 and history is set to 5). FIG. 5 is a graph showing the impact of kernel size on accuracy (in this graph, number of kernels is set to 32 and history is set to 5).

The interaction of these hyper-parameters can change the accuracy as well. For example, one may conclude from the above graphs that the best parameter configuration is {history=10, number of kernels=32, kernel size=4} but the accuracy of this configuration (0.994443) is slightly lower than the accuracy of the chosen configuration (0.994565).

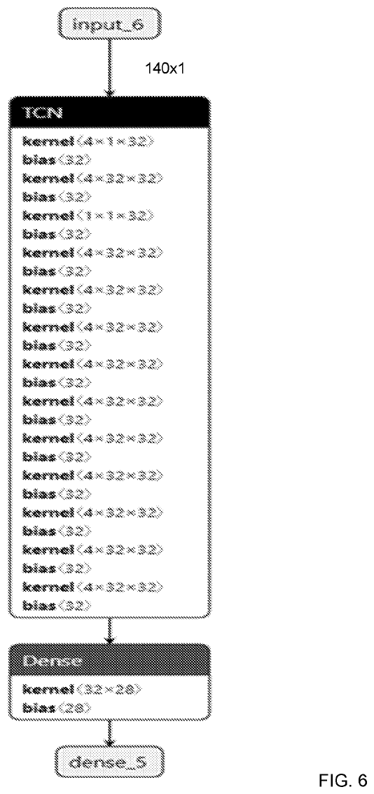

FIG. 6 illustrates the neural network architecture of this example. Because the the input vector (Xt) has 28 dimensions and the history is 5, the input is essentially a 5×28 matrix that can be flattened into a 140×1 vector. The last layer is a dense layer with 28 neurons and a softmax activation function. Because the configuration parameter return sequences is set to false in TCN, a slicing layer is used which changes the second dimension of the penultimate tensor from 140 to 1.

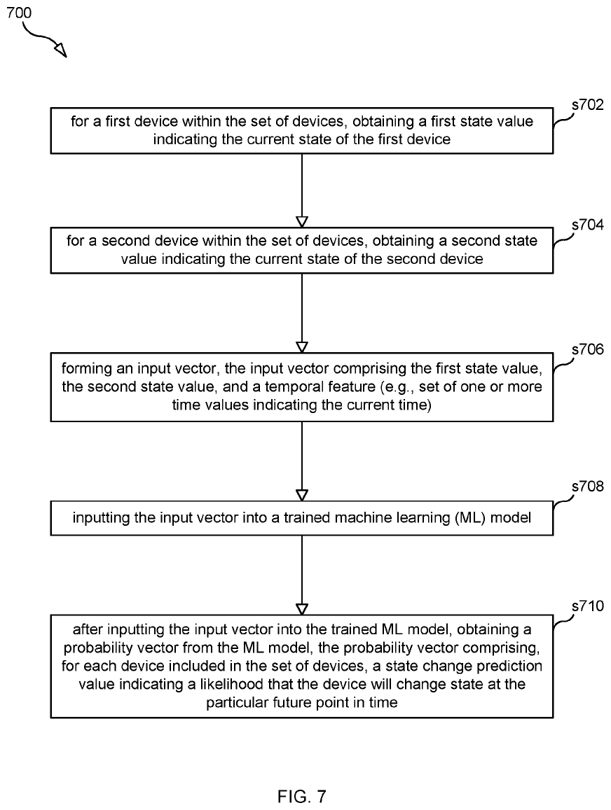

FIG. 7 is a flowchart illustrating a process 700, according to some embodiments, for predicting, for each device included in a set of devices, whether the device will change state at a particular future point in time. Process 700 may begin in step s702.

Step s702 comprises for a first device within the set of devices, obtaining a first state value indicating the current state of the first device.

Step s704 comprises for a second device within the set of devices, obtaining a second state value indicating the current state of the second device.

Step s706 comprises forming an input vector, the input vector comprising the first state value, the second state value, and temporal feature.

Step s708 comprises inputting the input vector into a trained machine learning (ML) model.

Step s710 comprises, after inputting the input vector into the trained ML model, obtaining a probability vector from the ML model, the probability vector comprising, for each device included in the set of devices, a state change prediction value indicating a likelihood that the device will change state at the particular future point in time.

In some embodiments, the method also includes generating a first device vector, the first device vector comprising the first state value indicating the current state of the first device; and generating a second device vector, the second device vector comprising the second state value indicating the current state of the second device, wherein forming the input vector comprises concatenating the first device vector with the second device vector.

In some embodiments, the first device vector further comprises a first spatial feature value indicating the current location of the first device, and the second device vector further comprises a second spatial feature value indicating the current location of the second device. In some embodiments, the first device vector further comprises a first type value indicating a type of the first device, and the second device vector further comprises a second type value indicating a type of the second device.

In some embodiments, the temporal feature comprises a set of one or more time values indicating the current time. In some embodiments, the set of one or more time values comprises at least one of: an hour value specifying an hour of the day; a day value specifying a day of the week; or a month value specifying a month of the year.

In some embodiments, the ML model was generated using a temporal convolutional network (TCN).

In some embodiments, process 700 further includes deciding whether or not to activate the first device based on the state change prediction value indicating the likelihood that the first device will change state at the particular future point in time.

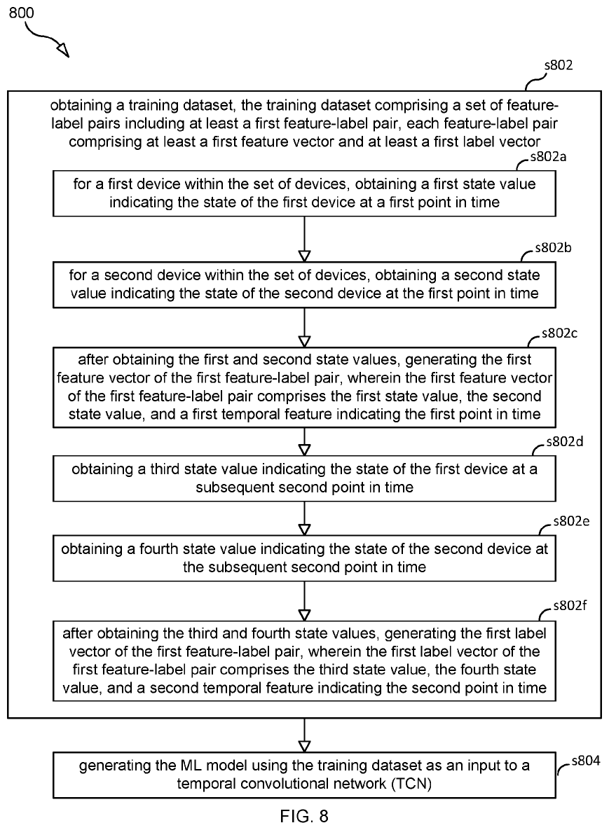

FIG. 8 is a flowchart illustrating a process 800, according to some embodiments, for producing a machine learning (ML) model for use in predicting, for each device included in a set of devices, whether the device will change state at a particular future point in time. Process 800 may begin in step s802.

Step s802 comprises obtaining a training dataset, the training dataset comprising a set of feature-label pairs including at least a first feature-label pair, each feature-label pair comprising at least a first feature vector and at least a first label vector.

Step s804 comprises generating the ML model using the training dataset as an input to a temporal convolutional network (TCN).

Step s802 comprises, for a first device within the set of devices, obtaining a first state value indicating the state of the first device at a first point in time (step s802a). Step s802 further comprises, for a second device within the set of devices, obtaining a second state value indicating the state of the second device at the first point in time (step s802b). Step s802 further comprises, after obtaining the first and second state values, generating the first feature vector of the first feature-label pair, wherein the first feature vector of the first feature-label pair comprises the first state value, the second state value, and a first temporal feature indicating the first point in time (step s802c). Step s802 further comprises obtaining a third state value indicating the state of the first device at a subsequent second point in time (step s802d). Step s802 further comprises, obtaining a fourth state value indicating the state of the second device at the subsequent second point in time (step s802e). Step s802 further comprises, after obtaining the third and fourth state values, generating the first label vector of the first feature-label pair, wherein the first label vector of the first feature-label pair comprises the third state value, the fourth state value, and a second temporal feature indicating the second point in time (step s802f).

In some embodiment process 800 further includes obtaining a first location value indicating the location of the first device at the first point in time; and obtaining a second location value indicating the location of the second device at the first point in time, wherein the first feature vector of the first feature-label pair further comprises the first location value and the second location value.

In some embodiments, the first feature-label pair further comprises a second feature vector, and obtaining the training dataset further comprises: for the first device within the set of devices, obtaining a fifth state value indicating the state of the first device at a second point in time that precedes the first point in time; for the second device within the set of devices, obtaining a sixth state value indicating the state of the second device at the second point in time; and after obtaining the fifth and sixth state values, generating the second feature vector of the first feature-label pair, wherein the second feature vector of the first feature-label pair comprises the fifth state value, the sixth state value, and a second temporal feature indicating the second point in time. In some embodiments, process 800 further comprises obtaining a third location value indicating the location of the first device at the second point in time; and obtaining a fourth location value indicating the location of the second device at the second point in time, wherein the second feature vector of the first feature-label pair further comprises the third location value and the fourth location value.

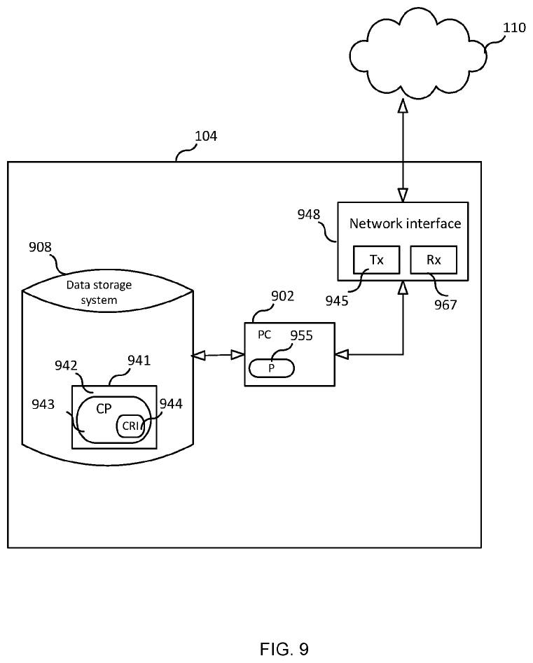

FIG. 9 is a block diagram of controller 104 according to some embodiments. As shown in FIG. 9, controller 104 may comprise: processing circuitry (PC) 902, which may include one or more processors (P) 955 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., controller 104 may be a distributed computing apparatus); at least one network interface 948 (e.g., a physical interface or air interface) comprising a transmitter (Tx) 945 and a receiver (Rx) 947 for enabling controller 104 to transmit data to and receive data from other nodes connected to a network 110 (e.g., an Internet Protocol (IP) network) to which network interface 948 is connected (physically or wirelessly) (e.g., network interface 948 may be coupled to an antenna arrangement comprising one or more antennas for enabling controller 104 to wirelessly transmit/receive data); and a local storage unit (a.k.a., “data storage system”) 908, which may include one or more non-volatile storage devices and/or one or more volatile storage devices. In embodiments where PC 902 includes a programmable processor, a computer program product (CPP) 941 may be provided. CPP 941 includes a computer readable medium (CRM) 942 storing a computer program (CP) 943 comprising computer readable instructions (CRI) 944. CRM 942 may be a non-transitory computer readable medium, such as, magnetic media (e.g., a hard disk), optical media, memory devices (e.g., random access memory, flash memory), and the like. In some embodiments, the CRI 944 of computer program 943 is configured such that when executed by PC 902, the CRI causes controller 104 to perform steps described herein (e.g., steps described herein with reference to the flow charts). In other embodiments, controller 104 may be configured to perform steps described herein without the need for code. That is, for example, PC 902 may consist merely of one or more ASICs. Hence, the features of the embodiments described herein may be implemented in hardware and/or software.

### CONCLUSION

An ML model for spatial-temporal event prediction of IoT devices in an IoT controlled environment is described above. When used by IoT device management (controller 104), the system will optimize the energy consumption of the battery powered devices by changing the sleep interval and by IoT service creation platforms to discover & recommend new services that increases user experience by learning the dependencies of these devices for an event.

While various embodiments are described herein, it should be understood that they have been presented by way of example only, and not limitation. Thus, the breadth and scope of this disclosure should not be limited by any of the above described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### REFERENCES

[1] Alemdar, Hande, et al. “ARAS human activity datasets in multiple homes with multiple residents.” 2013 7th International Conference on Pervasive Computing Technologies for Healthcare and Workshops. IEEE, 2013.
[2] Bai, Shaojie, J. Zico Kolter, and Vladlen Koltun. “An empirical evaluation of generic convolutional and recurrent networks for sequence modeling.” arXiv preprint arXiv:1803.01271 (2018).
[3] Kingma, Diederik P., and Jimmy Ba. “Adam: A method for stochastic optimization.” arXiv preprint arXiv:1412.6980 (2014).
[4] Reddi, Sashank J., Satyen Kale, and Sanjiv Kumar. “On the convergence of adam and beyond.” arXiv preprint arXiv:1904.09237 (2019).

1. A method for predicting, for each device included in a set of devices, whether the device will change state at a particular future point in time, the method comprising:
for a first device within the set of devices, obtaining a first state value indicating the current state of the first device;
for a second device within the set of devices, obtaining a second state value indicating the current state of the second device;
forming an input vector, the input vector comprising the first state value, the second state value, and temporal feature;
inputting the input vector into a trained machine learning (ML) model; and
after inputting the input vector into the trained ML model, obtaining a probability vector from the ML model, the probability vector comprising, for each device included in the set of devices, a state change prediction value indicating a likelihood that the device will change state at the particular future point in time.

2. The method of claim 1, further comprising:
generating a first device vector, the first device vector comprising the first state value indicating the current state of the first device; and
generating a second device vector, the second device vector comprising the second state value indicating the current state of the second device, wherein
forming the input vector comprises concatenating the first device vector with the second device vector.

3. The method of claim 2, wherein
the first device vector further comprises a first spatial feature value indicating the current location of the first device, and
the second device vector further comprises a second spatial feature value indicating the current location of the second device.

4. The method of claim 2, wherein
the first device vector further comprises a first type value indicating a type of the first device, and
the second device vector further comprises a second type value indicating a type of the second device.

5. The method of claim 1, wherein the temporal feature comprises a set of one or more time values indicating the current time.

6. The method of claim 5, wherein the set of one or more time values comprises:
an hour value specifying an hour of the day;
a day value specifying a day of the week; and/or
a month value specifying a month of the year.

7. The method of claim 1, wherein the ML model was generated using a temporal convolutional network (TCN).

8. The method of claim 1, further comprising:
deciding whether or not to activate the first device based on the state change prediction value indicating the likelihood that the first device will change state at the particular future point in time.

9. A method for producing a machine learning (ML) model for use in predicting, for each device included in a set of devices, whether the device will change state at a particular future point in time, the method comprising:
obtaining a training dataset, the training dataset comprising a set of feature-label pairs including at least a first feature-label pair, each feature-label pair comprising at least a first feature vector and at least a first label vector; and
generating the ML model using the training dataset as an input to a temporal convolutional network (TCN), wherein obtaining the training dataset comprises:
for a first device within the set of devices, obtaining a first state value indicating the state of the first device at a first point in time;
for a second device within the set of devices, obtaining a second state value indicating the state of the second device at the first point in time;
after obtaining the first and second state values, generating the first feature vector of the first feature-label pair, wherein the first feature vector of the first feature-label pair comprises the first state value, the second state value, and a first temporal feature indicating the first point in time;
obtaining a third state value indicating the state of the first device at a subsequent second point in time;
obtaining a fourth state value indicating the state of the second device at the subsequent second point in time; and
after obtaining the third and fourth state values, generating the first label vector of the first feature-label pair, wherein the first label vector of the first feature-label pair comprises the third state value, the fourth state value, and a second temporal feature indicating the second point in time.

10. The method of claim 9, further comprising
obtaining a first location value indicating the location of the first device at the first point in time; and
obtaining a second location value indicating the location of the second device at the first point in time, wherein
the first feature vector of the first feature-label pair further comprises the first location value and the second location value.

11. The method of claim 9, wherein
the first feature-label pair further comprises a second feature vector, and
obtaining the training dataset further comprises:
for the first device within the set of devices, obtaining a fifth state value indicating the state of the first device at a second point in time that precedes the first point in time;
for the second device within the set of devices, obtaining a sixth state value indicating the state of the second device at the second point in time;
after obtaining the fifth and sixth state values, generating the second feature vector of the first feature-label pair, wherein the second feature vector of the first feature-label pair comprises the fifth state value, the sixth state value, and a second temporal feature indicating the second point in time.

12. The method of claim 11, further comprising
obtaining a third location value indicating the location of the first device at the second point in time; and
obtaining a fourth location value indicating the location of the second device at the second point in time, wherein
the second feature vector of the first feature-label pair further comprises the third location value and the fourth location value.

13. A non-transitory computer readable storage medium storing a computer program comprising instructions which when executed by processing circuitry of a controller, causes the controller to perform the method of claim 1.

14. (canceled)

15. A controller, the controller comprising:
processing circuitry; and
a memory, the memory containing instructions executable by the processing circuitry, wherein the controller is configured to:
for a first device within a set of devices, obtain a first state value indicating the current state of the first device;
for a second device within the set of devices, obtain a second state value indicating the current state of the second device;
form an input vector, the input vector comprising the first state value, the second state value, and temporal feature;
input the input vector into a trained machine learning (ML) model; and
after inputting the input vector into the trained ML model, obtain a probability vector from the ML model, the probability vector comprising, for each device included in the set of devices, a state change prediction value indicating a likelihood that the device will change state at a particular future point in time.

16. The controller of claim 15, wherein the controller is further configured to:
generate a first device vector, the first device vector comprising the first state value indicating the current state of the first device; and
generate a second device vector, the second device vector comprising the second state value indicating the current state of the second device, wherein
forming the input vector comprises concatenating the first device vector with the second device vector.

17. A controller for producing a machine learning (ML) model for use in predicting, for each device included in a set of devices, whether the device will change state at a particular future point in time, the controller comprising:
processing circuitry; and
a memory, the memory containing instructions executable by the processing circuitry, wherein the controller is configured to:
obtain a training dataset, the training dataset comprising a set of feature-label pairs including at least a first feature-label pair, each feature-label pair comprising at least a first feature vector and a first label vector; and
generate the ML model using the training dataset as an input to a temporal convolutional network (TCN), wherein obtaining the training dataset comprises:
for a first device within the set of devices, obtaining a first state value indicating the state of the first device at a first point in time;
for a second device within the set of devices, obtaining a second state value indicating the state of the second device at the first point in time;
after obtaining the first and second state values, generating the first feature vector of the first feature-label pair, wherein the first feature vector of the first feature-label pair comprises the first state value, the second state value, and a first temporal feature indicating the first point in time;
obtaining a third state value indicating the state of the first device at a subsequent second point in time;
obtaining a fourth state value indicating the state of the second device at the subsequent second point in time; and
after obtaining the third and fourth state values, generating the first label vector of the first feature-label pair, wherein the first label vector of the first feature-label pair comprises the third state value, the fourth state value, and a second temporal feature indicating the second point in time.

18. The controller of claim 17, wherein the controller is further configured to:
obtain a first location value indicating the location of the first device at the first point in time; and
obtain a second location value indicating the location of the second device at the first point in time, wherein
the first feature vector of the first feature-label pair further comprises the first location value and the second location value.

19. (canceled)
